(19) United States
(12) Patent Application Publication
(10) Pub. No.: US 2022/0073157 A1
(43) Pub. Date: Mar. 10, 2022

(54) CRAWLER MONITORING SYSTEM, CRAWLER APPARATUS, CRAWLER VEHICLE, AND CRAWLER MONITORING METHOD

(71) Applicant: BRIDGESTONE CORPORATION, Tokyo (JP)

(72) Inventor: Ryo MIYAMOTO, Tokyo (JP)

(73) Assignee: BRIDGESTONE CORPORATION, Tokyo (JP)

(21) Appl. No.: 17/446,973

(22) Filed: Sep. 6, 2021

(30) Foreign Application Priority Data
Sep. 7, 2020 (JP) 2020-149691

(51) Int. Cl. B62D 55/084; B62D 55/24; B62D 55/12

(52) U.S. Cl. CPC B62D 55/0845; B62D 55/04; B62D 55/12; B62D 55/244

(57) ABSTRACT

A crawler monitoring system according to the present disclosure includes a sensor configured to acquire information on a distance between an elastic crawler and a drive wheel and a monitoring member configured to monitor whether a measured value measured based on the information from the sensor is a preset predetermined value or more.

### TECHNICAL FIELD

The present disclosure relates to a crawler monitoring system, a crawler apparatus, a crawler vehicle, and a crawler monitoring method.

### BACKGROUND

As a related art, for example, JP2011011622A (PTL 1) describes a monitoring device capable of determining, based on detected vibration data detected by a sensor and predicted vibration data predicted based on product information stored in an IC tag, whether a rubber crawler is abnormal.

### CITATION LIST

### Patent Literature

PTL 1: JP2011011622A

### SUMMARY

As a driving system of an elastic crawler, there is a system called a guide driving system. In the driving system, guide projections (drive projections) provided on an inner circumferential surface of the elastic crawler are pressed by drive pins provided on a drive sprocket, the drive sprocket rotates on the inner circumferential surface of the elastic crawler, and thus the elastic crawler is driven.

In the guide driving system, for example, when a large load is applied to the elastic crawler, the drive pins of the drive sprocket may ride over the guide projections of the elastic crawler. A phenomenon that the drive pins of the drive sprocket ride over the guide projections of the elastic crawler is also called “jumping”. The “jumping” may cause damage or dropout of the guide projections.

However, since the related art relates to the monitoring device for determining an abnormality of the elastic crawler, jumping cannot be prevented in advance.

The present disclosure is to provide a crawler monitoring system, a crawler apparatus, a crawler vehicle, and a crawler monitoring method capable of preventing jumping in advance.

A first aspect according to the present disclosure provides a crawler monitoring system configured to monitor a crawler apparatus including: an elastic crawler provided with a drive projection on an inner circumferential surface; and a drive sprocket including a drive pin capable of pressing the drive projection of the elastic crawler, and being rotatable along the inner circumferential surface of the elastic crawler, the crawler monitoring system including: a sensor configured to acquire information on a distance between the inner circumferential surface of the elastic crawler and the drive sprocket;

and a monitoring member configured to acquire the information from the sensor and monitor whether a measured value measured based on the information is a preset predetermined value or more.

A second aspect according to the present disclosure provides a crawler apparatus including: an elastic crawler provided with a drive projection on an inner circumferential surface; a drive sprocket including a drive pin capable of pressing the drive projection of the elastic crawler, and being rotatable along the inner circumferential surface of the elastic crawler; and the crawler monitoring system.

A third aspect according to the present disclosure provides a crawler vehicle in which a crawler apparatus is disposed on a vehicle front side and a vehicle rear side, the crawler apparatus including: an elastic crawler provided with a drive projection on an inner circumferential surface; and a drive sprocket including a drive pin capable of pressing the drive projection of the elastic crawler, and being rotatable along the inner circumferential surface of the elastic crawler, the crawler vehicle further including the crawler monitoring system, the sensor being provided in at least one crawler apparatus of the crawler apparatus on the vehicle front side and the crawler apparatus on the vehicle rear side.

A fourth aspect according to the present disclosure provides a crawler monitoring method for monitoring a crawler apparatus in which a drive projection provided on an inner circumferential surface of an elastic crawler is pressed by a drive pin provided on a drive sprocket and the drive sprocket rotates along the inner circumferential surface of the elastic crawler, the crawler monitoring method including: acquiring information on a distance between the inner circumferential surface of the elastic crawler and the drive sprocket; and monitoring whether a measured value measured based on the information is a preset predetermined value or more.

According to the present disclosure, it is possible to provide a crawler monitoring system, a crawler apparatus, a crawler vehicle, and a crawler monitoring method capable of preventing jumping in advance.

### BRIEF DESCRIPTION OF THE DRAWINGS

In the accompanying drawings:

FIG. 1 is a side view schematically illustrating a crawler vehicle according to an embodiment of the present disclosure;

FIG. 2 is an enlarged side view of a crawler apparatus provided in the crawler vehicle illustrated in FIG. 1;

FIG. 3 is an explanatory view for explaining an operation of the crawler apparatus illustrated in FIG. 2;

FIG. 4 is a perspective view illustrating a partial cross section of an elastic crawler adoptable to the crawler vehicle illustrated in FIG. 1 as an example;

FIG. 5 is a perspective view schematically illustrating a drive sprocket adoptable to the crawler vehicle illustrated in FIG. 1 as an example;

FIG. 6 is an enlarged explanatory view of FIG. 3 for explaining a state immediately before the elastic crawler causes jumping with respect to a drive wheel;

FIG. 7 is a block diagram schematically illustrating a crawler monitoring system according to the embodiment of the present disclosure;

FIG. 8 is a cross-sectional view taken along a line A-A in FIG. 2; and

FIG. 9 is a flowchart schematically illustrating a crawler monitoring method according to the embodiment of the present disclosure.

### DETAILED DESCRIPTION

A crawler monitoring system, a crawler apparatus, a crawler vehicle, and a crawler monitoring method according to an embodiment of the present disclosure will be described below with reference to the drawings.

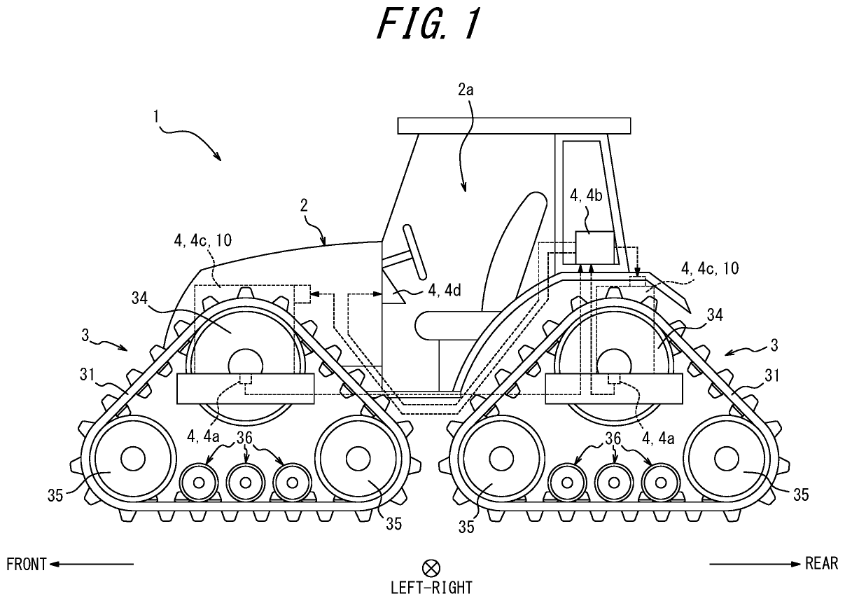

In FIG. 1, reference numeral 1 indicates a crawler vehicle according to an embodiment of the present disclosure. The crawler vehicle 1 includes a vehicle body 2 and a crawler apparatus 3 attached to the vehicle body 2. In the present embodiment, the crawler vehicle 1 includes four crawler apparatuses 3. In the present embodiment, a pair of crawler apparatuses 3 are disposed on a vehicle front side and a vehicle rear side, respectively. The pair of crawler apparatuses 3 are disposed in a vehicle left-right direction (vehicle width direction).

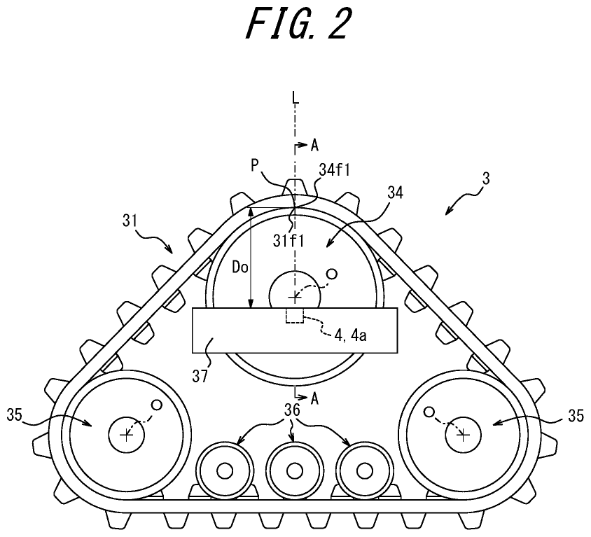

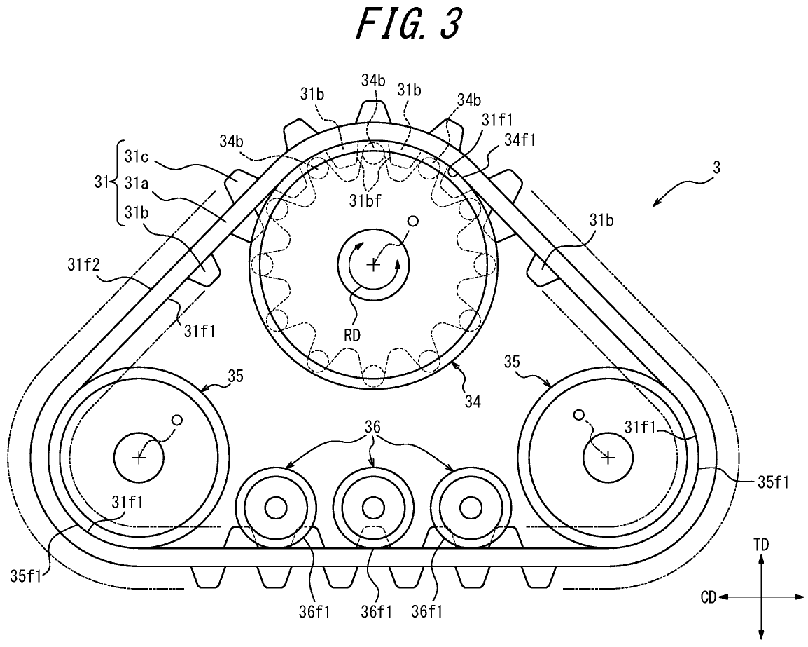

FIG. 2 illustrates an enlarged view of the crawler apparatus 3. The crawler apparatus 3 is a crawler apparatus to which a crawler monitoring system 4 (which will be described below) is applicable. FIG. 3 is an explanatory view illustrating an operation of the crawler apparatus 3. Referring to FIG. 3, the crawler apparatus 3 includes an elastic crawler 31 provided with drive projections 31b on an inner circumferential surface 31f1 and a drive wheel 34 including drive pins 34b capable of pressing the drive projections 31b of the elastic crawler 31 and being rotatable along the inner circumferential surface 31f1 of the elastic crawler 31.

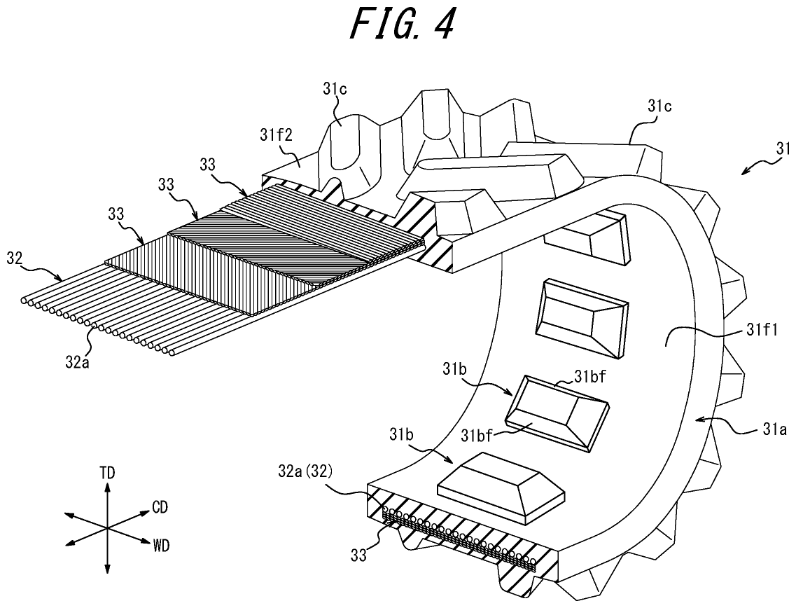

FIG. 4 illustrates a partial cross section of the elastic crawler 31 as an example. The terms “crawler inner circumferential side”, “crawler outer circumferential side”, “crawler circumferential direction”, “crawler width direction”, and “crawler thickness direction” are herein referred to as an inner circumferential side, an outer circumferential side, a circumferential direction, a width direction, and a thickness direction of a crawler body 31a, respectively. In the drawings, for convenience, the crawler circumferential direction is indicated by an arrow CD, the crawler width direction is indicated by an arrow WD, and the crawler thickness direction is indicated by an arrow TD.

In the present embodiment, the elastic crawler 31 is a coreless elastic crawler. The elastic crawler 31 is made of an elastic material. In this example, the elastic material is rubber. The elastic crawler 31 includes a crawler body 31a, drive projections 31b, and lugs 31c.

The crawler body 31a is formed in a shape of an endless belt. In the present embodiment, the crawler body 31a includes steel cord layers 32 and reinforcement plies 33 having one layer or a plurality of layer (three layers in the drawing as an example) which are embedded inside the crawler body 31a. Each of the steel cord layers 32 is formed of a plurality of steel cords 32a extending in parallel in the crawler circumferential direction. Each of the reinforcement plies 33 is disposed on an outer circumferential side of the crawler compared with the steel cord layers 32. The reinforcement ply 33 includes, for example, a plurality of cords inclined in the crawler circumferential direction. However, the reinforcement ply 33 may not be provided.

In the present embodiment, the elastic crawler 31 includes the plurality of drive projections 31b. Each of the plurality of projections 31b protrudes from the inner circumferential surface of the crawler body 31a toward the crawler inner circumferential side. In the present embodiment, the inner circumferential surface of the crawler body 31a corresponds to the inner circumferential surface 31f1 of the elastic crawler 31. In addition, the plurality of drive projections 3 lb are arranged at regular intervals in the crawler circumferential direction. In the present embodiment, the drive projection 31b are respectively disposed at a center of the crawler body 31a in the crawler width direction.

In the present embodiment, the elastic crawler 31 includes the plurality of lugs 31c. Each of the plurality of lugs 31c protrudes from the outer circumferential surface of the crawler body 31a toward the crawler outer circumferential side. In the present embodiment, the outer circumferential surface of the crawler body 31a corresponds to the outer circumferential surface 31f2 of the elastic crawler 31. The shapes and arrangement of the lugs 31c are not limited to those illustrated in the drawings, and any shape and arrangement thereof may be adopted.

In the present embodiment, the drive projections 31b and the lugs 31c can be formed integrally with the crawler body 31a. Further, the drive projections 31b and the lugs 31c can adhere to the crawler body 31a with vulcanization.

Referring to FIG. 3, the crawler apparatus 3 includes a drive wheel (drive sprocket) 34, an idling wheel (driven sprocket: idler) 35, and a track roller (track roller sprocket) 36. The drive wheel 34, the idling wheel 35, and the track roller 36 are rotating bodies attached to the vehicle body 2. The elastic crawler 31 is wound around the drive wheel 34, the idling wheel 35, and the track roller 36. Further, the crawler apparatus 3 includes a crawler monitoring system 4 to be described below.

The drive wheel 34 can spontaneously rotate around a rotational axis O using an internal combustion engine such as an engine or a motor as a driving source 10 (see FIG. 1), for example. In the present embodiment, the drive wheel 34 is a cage-type sprocket. The cage-type sprocket includes a plurality of drive pins 34b disposed around the rotational axis O at the same pitch. In the present embodiment, the drive wheel 34 includes an outer circumferential surface 34f1 that can come into contact with the inner circumferential surface 31f1 of the elastic crawler 31.

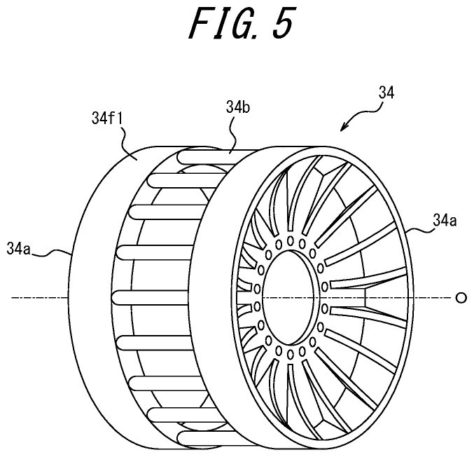

FIG. 5 schematically illustrates an example of the drive wheel 34. In the present embodiment, the drive wheel 34 includes two flange portions 34a. The two flange portions 34a are disposed at an interval in the axial direction. The two flange portions 34a are coupled to each other by the plurality of drive pins 34b. The plurality of drive pins 34b are disposed at intervals in the circumferential direction. In the present embodiment, an outer circumferential surface of the flange portion 34a is the outer circumferential surface 34f1 of the drive wheel 34. In the present embodiment, the axial direction means a direction extending parallel to the rotational axis O. In addition, the circumferential direction means a direction circulating around the axial direction.

Referring again to FIG. 3, the drive wheel 34 is disposed at a position higher than the idling wheel 35. The idling wheel 35 is a driven sprocket paired with the drive wheel 34. The idling wheel 35 and the track roller 36 rotate so as to follow the rotation of the drive wheel 34 via the elastic crawler 31. In the present embodiment, the idling wheel 35 and the track roller 36 are cage-type sprockets similar to the drive wheel 34. In the present embodiment, the crawler apparatus 3 includes two idling wheels 35 and three track rollers 36. However, the drive wheels 34, the idling wheels 35, and the track rollers 36 can be configured to be changed in number and arrangement according to specification requirements of the crawler apparatus 3.

Referring to FIG. 3, the outer circumferential surface 34f1 of the drive wheel 34 comes into contact with the inner circumferential surface 31f1 of the elastic crawler 31 through the elastic crawler 31 bridged therebetween. Thus, the outer circumferential surface 34f1 of the drive wheel 34 supports the inner circumferential surface 31f1 of the elastic crawler 31. In addition, an outer circumferential surface 35f1 of the idling wheel 35 also comes into contact with the inner circumferential surface 31f1 of the elastic crawler 31 through the elastic crawler 31 bridged therebetween. Thus, the outer circumferential surface 35f1 of the idling wheel 35 also supports the inner circumferential surface 31f1 of the elastic crawler 31. Further, in the present embodiment, an outer circumferential surface 36f1 of the track roller 36 also comes into contact with the inner circumferential surface 31f1 of the elastic crawler 31 through the elastic crawler 31 bridged therebetween. Thus, the outer circumferential surface 36f1 of the track roller 36 also supports the inner circumferential surface 31f1 of the elastic crawler 31.

The crawler apparatus 3 operates as follows, for example. As indicated by an arrow RD in FIG. 3, when the drive wheel 34 rotates around the rotational axis O, the drive pins 34b of the drive wheel 34 sequentially press side surfaces 31b f in the crawler circumferential direction of the drive projections 31b of the elastic crawler 31 corresponding to the drive pins 34b. Thereby, the drive wheel 34 pulls the elastic crawler 31 in the crawler circumferential direction. At this time, the idling wheel 35 and the track roller 36 rotate in the same direction of the drive wheel 34 due to a pulling force of the elastic crawler 31. In other words, the elastic crawler 31 rotates around the drive wheel 34, the idling wheel 35, and the track roller 36 when the drive wheel 34 rotates. Therefore, the crawler apparatus 3 can drive the elastic crawler 31 by rotating the drive wheel 34.

However, as described above, when a driving system of the elastic crawler 31 is a so-called guide driving system in which the drive pins 34b of the drive wheel 34 presses the drive projections 31b of the elastic crawler 31 to drive the elastic crawler 31, the drive pins 34b of the drive wheel 34 ride over the drive projections 31b provided on the elastic crawler 31, and thus a phenomenon called “jumping” may occur.

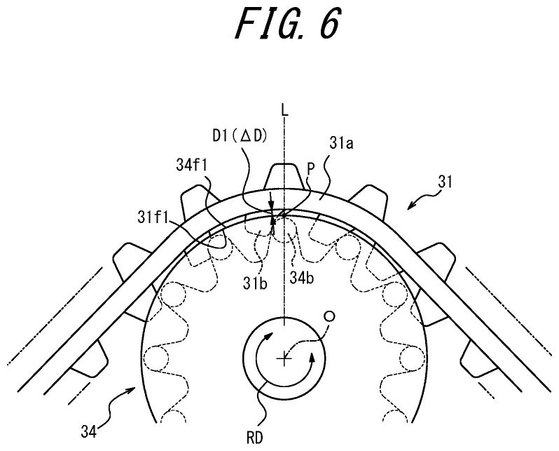

FIG. 6 is an enlarged view of FIG. 3 illustrating a state immediately before the elastic crawler 31 causes jumping with respect to the drive wheel 34. When the drive pins 34b of the drive wheel 34 ride over the drive projections 31b of the elastic crawler 31 from the state of FIG. 6, the drive projections 31b are damaged, and the drive projections 31b come off. This is because when the drive pins 34b ride over the drive projections 31b, a large strain is generated in the drive projections 31b. The phenomenon of “jumping” leads to a decrease in product life, a decrease in driving force, and a work stoppage.

Since the “jumping” occurs when the drive pins 34b of the drive wheel 34 ride over the drive projections 31b of the elastic crawler 31, the “jumping” can be prevented in advance by monitoring of riding of the drive pins 34b over the drive projections 31b.

When the elastic crawler 31 is wound around the drive wheel 34, the inner circumferential surface 31f1 of the elastic crawler 31 is in contact with the outer circumferential surface 34f1 of the drive wheel 34. However, when the drive pins 34b of the drive wheel 34 try to ride over the drive projections 31b of the elastic crawler 31, a gap is formed between the inner circumferential surface 31f1 of the elastic crawler 31 and the outer circumferential surface 34f1 of the drive wheel 34, as indicated by reference numeral D1 in FIG. 6.

Therefore, according to the present disclosure, a sensor 4a acquires information S on the distance D1 between the inner circumferential surface 31f1 of the elastic crawler 31 and the outer circumferential surface 34f1 of the drive wheel 34, thereby monitoring the occurrence of the “jumping”. In the present embodiment, the distance D1 is a gap between the inner circumferential surface 31f1 of the elastic crawler 31 and the outer circumferential surface 34f1 of the drive wheel 34.

The distance D1 can be calculated, as a measured value D, based on the information S acquired by the sensor 4a. When it is determined that the distance D1 calculated based on the information S is a preset predetermined value Dv1 or more, it is considered that “jumping” may occur, and a countermeasure is taken to prevent the “jumping”. As such a measure, for example, an operator is notified by visual means or auditory means that the rotation of the drive wheel 34 may be reduced or stopped or the “jumping” may occur.

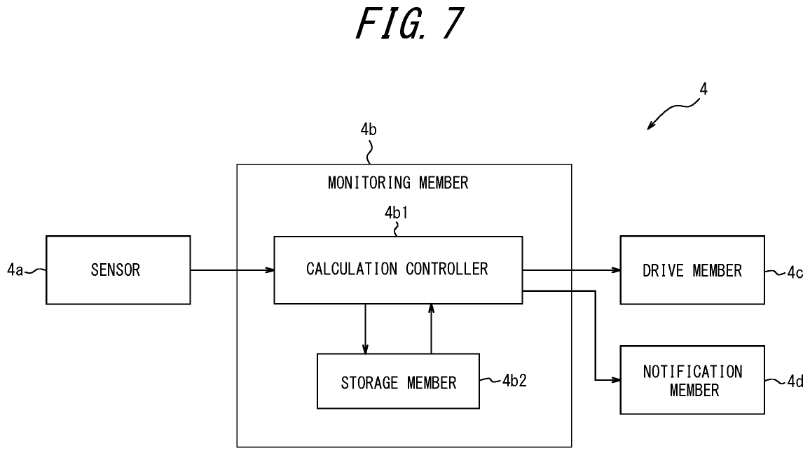

FIG. 7 is a block diagram schematically illustrating the crawler monitoring system 4 according to the embodiment of the present disclosure.

The crawler monitoring system 4 is a system that monitors the crawler apparatus 3. Herein, the crawler monitoring system 4 includes not only a system that monitors at least one of the four crawler apparatuses 3 as a whole, but also individual crawler monitoring devices provided respectively in the four crawler apparatuses 3. The crawler monitoring system 4 includes a sensor 4a and a monitoring member 4b. The sensor 4a is a sensor configured to acquire the information S on the distance D1 between the inner circumferential surface 31f1 of the elastic crawler 31 and the drive wheel 34. The monitoring member 4b acquires the information S from the sensor 4a, and monitors whether the measured value D measured based on the information S is a preset predetermined value Dv or more. When the measured value D is the distance D1, an example of the predetermined value Dv1 may include a value Dv1 (hereinafter, also referred to as a “predetermined value Dv1”) corresponding to the gap between the inner circumferential surface 31f1 of the elastic crawler 31 and the outer circumferential surface 34f1 of the drive wheel 34 immediately before the drive pin 34b rides over the drive projection 31b. More preferably, an example of the predetermined value Dv1 may include a value corresponding to the gap between the inner circumferential surface 31f1 of the elastic crawler 31 and the outer circumferential surface 34f1 of the drive wheel 34 such that the drive pin 34b is pushed back by an elastic force of the drive projection 31b without riding over the drive projection 31b when a drive member 4c such as an engine is stopped.

An example of the sensor 4a may include a sensor configured to acquire information S on a distance Do to the inner circumferential surface 31f1 of the elastic crawler 31. An example of such a sensor may include a displacement sensor (displacement meter). According to the displacement sensor, it is possible to acquire not only the information S on the distance Do between the sensor 4a and the inner circumferential surface 31f1 of the elastic crawler 31 but also the information S on a displacement ΔD of the inner circumferential surface 31f1 of the elastic crawler 31 with respect to the sensor 4a, as the information S on the distance D1.

In the present embodiment, as illustrated in FIG. 1 and the like, the sensor 4a is one sensor 4a provided for one crawler apparatus 3. However, the sensor 4a preferably includes a plurality of sensors 4a disposed in one crawler apparatus 3 in the crawler circumferential direction. The sensor 4a may be a contact type sensor or a non-contact type sensor, but preferably the non-contact type sensor such as an optical displacement sensor, a linear displacement sensor, or an ultrasonic displacement sensor. In addition, the sensor 4a may include any sensor capable of acquiring the information S on the distance D1 between the inner circumferential surface 31f1 of the elastic crawler 31 and the drive wheel 34, without being limited to the displacement sensor. For example, the sensor 4a may be a distance sensor.

However, as in the displacement sensor, it is preferable that the information S on the displacement ΔD when the inner circumferential surface 31f1 of the elastic crawler 31 is displaced with respect to the sensor 4a. In this case, the monitoring member 4b acquires the information S from the sensor 4a, sets the displacement ΔD measured based on the information S as the measured value D, and monitors whether the displacement ΔD is a preset predetermined value Dv2 or more. The displacement ΔD is a positional displacement (displacement amount) of the inner circumferential surface 31f1 of the elastic crawler 31 when the inner circumferential surface 31f1 of the elastic crawler 31 is displaced with respect to the sensor 4a. Referring to FIG. 6, the displacement ΔD is a displacement of the inner circumferential surface 31f1 of the elastic crawler 31 when the inner circumferential surface 31f1 of the elastic crawler 31 with reference to a position (apex P) where the inner circumferential surface 31f1 of the elastic crawler 31 is in contact with the outer circumferential surface 34f1 of the drive wheel 34. A vector of the displacement is positive in a direction away from the sensor 4a. In this case, an example of the predetermined value Dv2 may include a value corresponding to a displacement of the inner circumferential surface 31f1 of the elastic crawler 31 immediately before the drive pin 34b rides over the drive projection 31b. More preferably, an example of the predetermined value Dv2 may include a value corresponding to a displacement of the inner circumferential surface 31f1 of the elastic crawler 31 such that the drive pin 34b is pushed back by the elastic force of the drive projection 31b without riding over the drive projection 31b when a drive member 4c such as an engine is stopped. In this case, the monitoring member 4b may calculate the displacement ΔD without calculating the distance D1 and compare the displacement ΔD with the predetermined value Dv2. Therefore, it is possible to reduce calculation processing in the monitoring member 4b. An example of such a displacement sensor may include a laser displacement meter.

In the crawler monitoring system 4, when determining that the measured value D is the predetermined value Dv or more, the monitoring member 4b preferably reduces or stops the rotation of the drive wheel 34, or notifies that the measured value D is the predetermined value Dv or more. In this case, the jumping of the drive wheel 34 can be forcibly or indirectly prevented in advance.

In the crawler monitoring system 4, the monitoring member 4b controls the drive member 4c and a notification member 4d based on the information S acquired from the sensor 4a to prevent the jumping in advance.

Referring to FIG. 7, the monitoring member 4b includes a calculation controller 4b1 and a storage member 4b2. The calculation controller 4b1 executes a program stored in the storage member 4b2 to calculate the measured value D, and compares the measured value D with the predetermined value Dv. Further, the calculation controller 4b1 executes the program stored in the storage member 4b2 to control the drive member 4c and the notification member 4d. The calculation controller 4b1 is configured by processors, for example, a central processing member (CPU) and a micro processing member (MPU). The calculation controller 4b1 may be configured by at least one processor. The processor can be implemented by an integrated circuit (IC), for example. Further, the processor can be implemented according to various other existing known means. The storage member 4b2 stores the information S acquired from the sensor 4a and the program. The storage member 4b2 is configured by a memory such as a random access memory (RAM) or a read only memory (ROM). The storage member 4b2 can also be configured by an external storage device such as a magnetic disk or a memory card (for example, USB). The monitoring member 4b can be configured by a computer, for example.

Referring to FIG. 1, the crawler monitoring system 4 according to the present embodiment monitors each of the four crawler apparatuses 3, as the entire system of the crawler vehicle 1, using one monitoring member 4b. However, the crawler monitoring system 4 may have a configuration in which four monitoring members 4b are provided in the four crawler apparatuses 3, as crawler monitoring devices provided in the four crawler apparatuses 3.

Referring to FIG. 1, the drive member 4c includes a power source 10 used to rotate the drive wheels 34. Examples of the power source 10 may include an engine and a motor. When the power source 10 is an engine, the monitoring member 4b can reduce or stop the rotation of the drive wheels 34 by controlling a fuel supply device, an ignition device, an intake air control device and the like. When the power source 10 is a motor, the monitoring member 4b can reduce or stop the rotation of the drive wheels 34 by controlling supplied power, for example.

The notification member 4d includes an alarm device that issues an alarm to an operator (driver) in a driving cab 2a of the vehicle body 2. Examples of the alarm device may include perception devices, for example, a visual device and an auditory device. When the notification member 4d is a visual device, the monitoring member 4b controls the visual device to issue an alarm to the operator. The visual device displays visual information, for example, colors, letters, and symbols. Examples of the visual device may include a display, a monitor, and an alarm lamp disposed in the driving cab 2a. When the notification member 4d is an auditory device, the monitoring member 4b controls the auditory device to issue an alarm to the operator. The auditory device produces sounds such as voice. Examples of the auditory device may include a buzzer and a speaker.

In the present embodiment, the sensor 4a is located to be overlapped on a width direction end 31e of the elastic crawler 31 in the crawler width direction as viewed in the crawler circumferential direction.

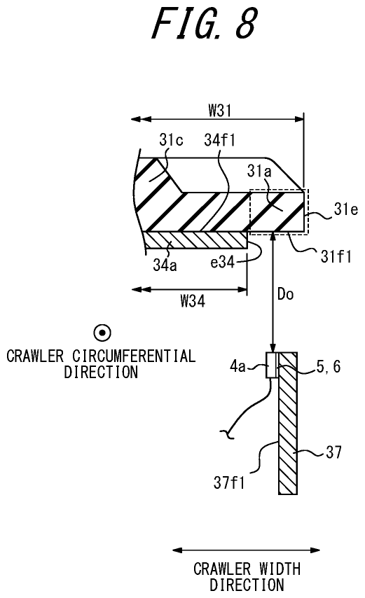

FIG. 8 is a cross-sectional view taken along a line A-A in FIG. 2. Referring to FIG. 8, an axial direction width W34 of the drive wheel 34 is narrower than a width (axial direction width) W31 of the elastic crawler 31. Therefore, the width direction end (axial direction width) 31e of the elastic crawler 31 is exposed from an axial direction end e34 of the drive wheel 34. Accordingly, when the sensor 4a is disposed to be capable of detecting the inner circumferential surface 31f1 of the elastic crawler 31 at the width direction end 31e of the elastic crawler 31, it is possible to easily detect that the distance D1 between the inner circumferential surface 31f1 of the elastic crawler 31 and the outer circumferential surface 34f1 of the drive wheel 34 is displaced when the drive pin 34b of the drive wheel 34 rides over the drive projection 31b of the elastic crawler 31.

In the present embodiment, the sensor 4a is disposed on a sprocket frame 37. The sprocket frame 37 is used to fix the drive wheel 34 to the vehicle body 2. Referring to FIG. 2, the sprocket frame 37 is disposed to be located below the rotational axis O of the drive wheel 34. Further referring to FIG. 2, in the present embodiment, the sensor 4a is disposed on a vertical line L passing through the rotational axis O of the drive wheel 34. In the present embodiment, the sensor 4a can acquire the information S on the distance D1 (see FIG. 6) between the inner circumferential surface 31f1 of the elastic crawler 31 and the outer circumferential surface 34f1 of the drive wheel 34 at the uppermost apex P of the outer circumferential surface 34f1 of the drive wheel 34. In the present embodiment, the sensor 4a is disposed at a position separated by a distance Do from the apex P. In the present embodiment, the displacement ΔD (see FIG. 6) is positive in a direction away from the sensor 4a rather than the distance Do.

Further, as illustrated in FIG. 8, the crawler monitoring system 4 preferably includes a heat insulating member 5 that covers the sensor 4a. The heat insulating member 5 can protect the sensor 4a from a temperature. For example, the sprocket frame 37 is mainly made of metal, and a temperature is expected to rise due to direct sunlight. In reality, it is known that a temperature rises to 70° C. in the vicinity of the sprocket frame 37. Therefore, the heat insulating member 5 preferably has heat resistance of at least 70° C. or higher. Examples of the heat insulating member 5 may include a polyurethane foam member, a fluorine resin member, a silicon member, and a rubber member.

In addition, as illustrated in FIG. 8, the crawler monitoring system 4 preferably includes a cushion member 6 that covers the sensor 4a. In this case, the sensor can be protected from vibration. Examples of the cushion member 6 may include a polyurethane foam member, a rubber member, and a silicon member.

In the present embodiment, the sensor 4a is fixed to an inner side surface (side surface on the frame side) 37f1 of the sprocket frame 37. Thus, the sensor 4a can be prevented from being exposed to direct sunlight. Each of the heat insulating member 5 and the cushion member 6 preferably covers the entire sensor 4a excluding a detection member of the sensor 4a. In the present embodiment, the sensor 4a is fixed to the sprocket frame 37 through the heat insulating member 5 and the cushion member 6. In this case, the sensor 4a may be fixed to the sprocket frame 37 through at least one of the heat insulating member 5 and the cushion member 6. When the heat insulating member 5 and the cushion member 6 are laminated, the order of laminating the heat insulating member 5 and the cushion member 6 from the sprocket frame 37 is not particularly limited. Further, the heat insulating member 5 and the cushion member 6 can be configured by one member having both heat insulating performance and cushion performance (vibration-proof/vibration-damping performance). Examples of such a member may include a polyurethane foam member, a rubber member, and a silicon member.

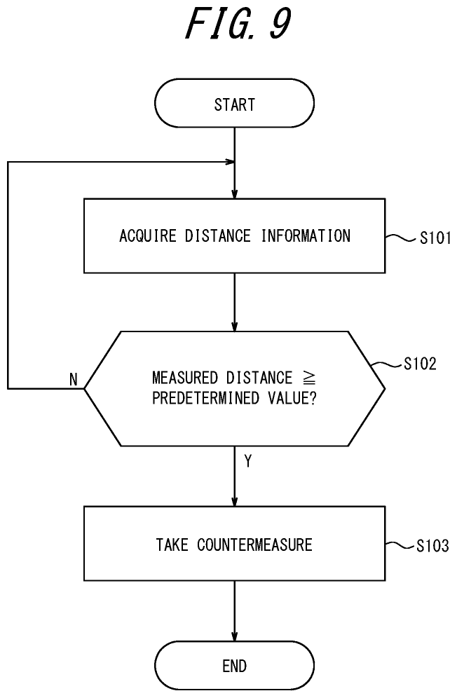

FIG. 9 is a flowchart schematically illustrating a crawler monitoring method according to the embodiment of the present disclosure. The crawler monitoring method according to the present embodiment is a method of monitoring the crawler apparatus 3. The crawler monitoring method according to the present embodiment includes: performing calculation processing, based on the information S acquired from the sensor 4a as an input, using the monitoring member 4b; outputting a command according to the result of the calculation processing to the drive member 4c and the notification member 4d; and operating the drive member 4c and the notification member 4d not to cause jumping.

The crawler monitoring method according to the present embodiment is performed in real time at a predetermined sampling frequency. The crawler monitoring method according to the present embodiment is initiated by starting the operation of the power source 10 such as an engine or a motor.

Referring to FIG. 9, in step 101, information S on a distance D1 between the inner circumferential surface 31f1 of the elastic crawler 31 and the drive wheel 34 is acquired.

In the present embodiment, the distance D1 is a gap between the inner circumferential surface 31f1 of the elastic crawler 31 and the outer circumferential surface 34f1 of the drive wheel 34. When D1≤0, the inner circumferential surface 31f1 of the elastic crawler 31 and the outer circumferential surface 34f1 of the drive wheel 34 are in contact with each other without a gap therebetween. On the other hand, when D1>0, the inner circumferential surface 31f1 of the elastic crawler 31 and the outer circumferential surface 34f1 of the drive wheel 34 are separated from each other with a gap formed therebetween.

In the present embodiment, the information S acquired by the sensor 4a is information on the positional displacement ΔD of the inner circumferential surface 31f1 of the elastic crawler 31 with respect to the sensor 4a. As described above, the displacement ΔD is a displacement of the inner circumferential surface 31f1 of the elastic crawler 31 with reference to the position (apex P) where the inner circumferential surface 31f1 of the elastic crawler 31 is in contact with the outer circumferential surface 34f1 of the drive wheel 34. A vector of the displacement is positive in a direction away from the sensor 4a. In the present embodiment, when ΔD≤0, the position of the inner circumferential surface 31f1 of the elastic crawler 31 is not displaced with respect to the sensor 4a. Therefore, it can be known from the information S acquired by the sensor 4a that the inner circumferential surface 31f1 of the elastic crawler 31 and the outer circumferential surface 34f1 of the drive wheel 34 are in contact with each other without a gap therebetween. On the contrary, in the present embodiment, when ΔD>0, the position of the inner circumferential surface 31f1 of the elastic crawler 31 is displaced with respect to sensor 4a in a direction away from the sensor 4a. Therefore, it can be known from the information S acquired by the sensor 4a that the inner circumferential surface 31f1 of the elastic crawler 31 and the outer circumferential surface 34f1 of the drive wheel 34 are separated from each other with a gap formed therebetween.

Next, in step 102, it is monitored whether the measured value D measured based on the information S is a preset predetermined value Dv or more.

As described above, the information S acquired by the sensor 4a is information on the distance (gap) D1 between the inner circumferential surface 31f1 of the elastic crawler 31 and the outer circumferential surface 34f1 of the drive wheel 34. For example, when the information S is information used to measure the distance D1, a predetermined value Dv1 is used as a predetermined value Dv. The predetermined value Dv1 is used to determine whether the distance D1 between the inner circumferential surface 31f1 of the elastic crawler 31 and the outer circumferential surface 34f1 of the drive wheel 34 is a gap that can cause jumping.

When the distance D1 is less than the predetermined value Dv1 (D1<Dv1), it is determined that there is a gap with which the drive pins 34b of the drive wheel 34 does not ride over the drive projections 31b of the elastic crawler 31. In other words, when D1<Dv1, it is determined that the distance D1 is a narrow gap that does not cause jumping. Therefore, in this case, it is determined that jumping does not occur, and the process returns to step 101.

On the other hand, when the measured value D is the predetermined value Dv or more (D≥Dv), it is determined that the drive pins 34b of the drive wheel 34 can ride over the drive projections 31b of the elastic crawler 31. In this example, when the distance D1 is the predetermined value Dv1 or more (D1≥Dv1), it is determined that there is a gap with which the drive pins 34b of the drive wheel 34 can ride over the drive projections 31b of the elastic crawler 31. In other words, when D1≥Dv1, it is determined that the distance D1 is a wide gap that can cause jumping. Therefore, in this case, it is determined that jumping may occur, and the process proceeds to step 103 to take a countermeasure to prevent the jumping. An example of the countermeasure may include a countermeasure to reduce or stop the rotation of the drive wheel 34 under control of the drive member 4c. Further, an example of the countermeasure may include a countermeasure to notify through the notification member 4d that the measured distance D1 is the predetermined value Dv1 or more, that is, jumping may occur. Alternatively, the operations of the drive member 4c and the notification member 4d can be used together.

Particularly, according to the present embodiment, the information S acquired by the sensor 4a in step 101 indicates the positional displacement ΔD of the inner circumferential surface 31f1 of the elastic crawler 31 when the inner circumferential surface 31f1 of the elastic crawler 31 is displaced with respect to the sensor 4a as described above. In step 102, the displacement ΔD measured based on the information S is set as the measured value D and the predetermined value Dv2 is used. In step 102, it is monitored whether the displacement ΔD is the preset predetermined value Dv2 or more. In this example, the predetermined value Dv2 is used to determine whether the displacement ΔD of the inner circumferential surface 31f1 of the elastic crawler 31 is a displacement that can cause jumping.

When the displacement ΔD is less than the predetermined value Dv2 (ΔD<Dv2), it is determined that the position of the inner circumferential surface 31f1 of the elastic crawler 31 is hardly displaced with respect to the sensor 4a. In other words, when ΔD<Dv2, as in the case where the distance D1 is considered as a gap between the inner circumferential surface 31f1 of the elastic crawler 31 and the outer circumferential surface 34f1 of the drive wheel 34, it is determined that the drive pins 34b of the drive wheel 34 do not ride over the drive projections 31b of the elastic crawler 31. Therefore, in this case, it is determined that jumping does not occur, and the process returns to step 101.

On the other hand, when the displacement ΔD is the predetermined value Dv2 or more (ΔD≥Dv2), it is determined that the drive pins 34b of the drive wheel 34 can ride over the drive projections 31b of the elastic crawler 31. In other words, when ΔD≥Dv2, it is determined that the displacement ΔD of the inner circumferential surface 31f1 of the elastic crawler 31 is a large displacement that can cause jumping. Therefore, in this case, it is determined that jumping may occur, the process proceeds to step 103 to take a countermeasure to prevent the jumping. As the countermeasure, the rotation of the drive wheels 34 can be reduced or stopped under control of the drive member 4c, as in the case where the distance D1 is considered. Further, as the countermeasure, it is possible to notify through the notification member 4d that the displacement ΔD as the measured distance is the predetermined value Dv2 or more, that is, jumping may occur. Alternatively, the operations of the drive member 4c and the notification member 4d can be used together.

The crawler monitoring method according to the present embodiment is executed when the information S acquired by the sensor 4a is input to the monitoring member 4b. In the present embodiment, a sampling frequency (Hz) at the time of acquiring the information S from the sensor 4a can be 1 Hz or more. Preferably, the sampling frequency (Hz) is equal to the number of times the drive projections 31b of the elastic crawler 31 pass through the sensor 4a per unit time. In this case, all of the drive projections 31b of the elastic crawler 31 can be monitored. For example, when the number of times the drive projections 31b of the elastic crawler 31 pass per unit time is 30 Hz, the sampling frequency is 30 Hz. More preferably, the sampling frequency (Hz) is an integral multiple of the number of times the drive projections 31b of the elastic crawler 31 pass per unit time. In this case, more detailed monitoring can be performed. For example, when the number of times the drive projections 31b of the elastic crawler 31 pass per unit time is 30 Hz, the sampling frequency can be 60 Hz or 90 Hz which is an integral multiple of 30 Hz.

In the crawler monitoring system 4, the sensor 4a may communicate with the monitoring member 4b in a wired or wireless manner, the monitoring member 4b may communicate with the drive member 4c in a wired or wireless manner, and the monitoring member 4b may communicate with the notification member 4d in a wired or wireless manner.

Examples of a power supply for the crawler monitoring system for the crawler monitoring system 4 may include a vehicle power supply (vehicle battery) mounted on the vehicle body 2 and an external power supply separately provided for the crawler monitoring system 4. However, as the power supply for the crawler monitoring system, the vehicle power supply is preferably used. In this case, the crawler monitoring system 4 can be activated at the same time when the power is supplied to the vehicle. In addition, when the external power supply is used, the power to be supplied to the crawler monitoring system 4 is limited, and it is necessary to replace the external power supply. However, when the vehicle power supply is used, since a battery is charged during use of the vehicle, it is not necessary to replace the power supply as a power supply for the crawler monitoring system.

In order to confirm data at a later date, the crawler monitoring system 4 can save the data in the storage member 4b2. Alternatively, the crawler monitoring system 4 may further include a storage medium such as a data logger independent of the storage member 4b2. In this case, the data can be saved in the storage medium.

Referring to FIG. 7, the crawler monitoring system 4 includes the sensor 4a configured to acquire the information S on the distance D1 between the inner circumferential surface 31f1 of the elastic crawler 31 and the drive wheel 34 and the monitoring member 4b configured to acquire the information S from the sensor 4a and monitor whether the measured value D (D1, ΔD) measured based on the information S is the preset predetermined value Dv (Dv1, Dv2) or more. According to the crawler monitoring system 4, the jumping on the drive wheel 34 can be detected in advance.

In the crawler monitoring system 4, when determining that the measured value D (D1, ΔD) is the predetermined value Dv (Dv1, Dv2) or more, the monitoring member 4b reduces or stops the rotation of the drive wheels 34 under control of the drive member 4c, or notifies through the notification member 4d that the measured value D (D1, ΔD) is the predetermined value Dv (Dv1, Dv2) or more. In this case, the jumping can be prevented in advance by the control of the rotation of the drive wheels 34 or the advance notification of the jumping for the purpose of preventing the jumping.

Referring to FIG. 8, the crawler monitoring system 4 includes the heat insulating member 5 that covers the sensor 4a. In this case, the sensor 4a is protected from a temperature, and thus the sensor 4a can be improved in durability.

Referring to FIG. 8, the crawler monitoring system 4 includes the cushion member 6 that covers the sensor 4a. In this case, the sensor 4a is protected from vibration, and thus the sensor 4a can be improved in durability.

In the crawler monitoring system 4, the sensor 4a preferably includes a plurality of sensors disposed in the crawler circumferential direction. In this case, the behavior of the inner circumferential surface 31f1 of the elastic crawler 31 is monitored in more detail, and thus jumping can be detected in advance with higher accuracy.

Referring to FIG. 8, the sensor 4a in the crawler monitoring system 4 is located to be overlapped on the width direction end 31e of the elastic crawler 31 in the crawler width direction as viewed in the crawler circumferential direction. In this case, the behavior of the inner circumferential surface 31f1 of the elastic crawler 31 can be easily monitored without obstruction of the vehicle body 2 and the crawler apparatus 3. Therefore, in this case, jumping can be detected in advance by a simple method.

Referring to FIG. 8, the sensor 4a in the crawler monitoring system 4 is disposed on the sprocket frame 37. In this case, jumping can be detected in advance by a simple method using an existing member.

Referring to FIG. 2, in the crawler monitoring system 4, the drive wheel 34 is disposed at the position higher than the idling wheel 35 paired with the drive wheel 34. In this case, since the idling wheel 35 is in a state of being pulled up by the elastic crawler 31, the drive pins of the idling wheel 35 hardly cause jumping with respect to the drive projections 31b of the elastic crawler 31. Accordingly, in this case, jumping can be detected in advance by a simple method of paying attention to the jumping on the drive wheel 34.

Referring to FIG. 1, the crawler apparatus 3 includes the elastic crawler 31, the drive wheel 34, and the crawler monitoring system 4. According to the crawler apparatus 3, jumping can be detected in advance.

Referring to FIG. 1, the crawler vehicle 1 is a crawler vehicle in which the crawler apparatuses 3 are disposed on the front side and the rear side of the vehicle. The crawler vehicle 1 further includes the crawler monitoring system 4 described above. The sensor 4a can be provided in at least one crawler apparatus 3 of the crawler apparatus 3 on the vehicle front side and the crawler apparatus 3 on the vehicle rear side. Accordingly, according to the crawler vehicle 1, jumping on the drive wheel 34 can be detected in advance.

In the crawler vehicle 1, the sensor 4a is preferably provided in at least one crawler apparatus having a large applied load of the crawler apparatus 3 on the vehicle front side and the crawler apparatus 3 on the vehicle rear side. In this case, it is possible to detect jumping in the crawler apparatus 3, which tends to cause jumping, in advance. For example, when the crawler vehicle 1 is a tractor, a working machine called an implement is attached to the vehicle rear side to pull. In this case, a large load is applied to the rear side of the crawler vehicle 1. Accordingly, in this case, the sensor 4a is preferably provided at least the crawler apparatus 3 on the vehicle rear side.

In the crawler vehicle 1, the sensor 4a is preferably provided in every crawler apparatus 3. In this case, jumping in all of the four crawler apparatuses 3 can be detected in advance. Referring to FIG. 1, the crawler vehicle 1 has a configuration in which the sensor 4a is provided in every crawler apparatus 3.

The crawler monitoring method described with reference to FIG. 9 includes: acquiring the information S on the distance D1 (ΔD) between the inner circumferential surface 31f1 of the elastic crawler 31 and the drive wheel 34; and monitoring whether the measured distance D1 (ΔD) measured based on the information S is the preset predetermined value Dv1 (Dv2) or more. According to the crawler monitoring method of the present disclosure, jumping can be detected in advance.

The crawler monitoring method described with reference to FIG. 9 further includes: reducing or stopping the rotation of the drive wheel 34 using the drive member 4c when it is determined that the measured value D (D1, ΔD) is the predetermined value Dv (Dv1, Dv2) or more or notifying using the notification member 4d that measured value D (D1, ΔD) is the predetermined value Dv (Dv1, Dv2) or more. In this case, jumping can be prevented in advance by the control of the rotation of the drive wheels 34 or the advance notification of the jumping to the operator for the purpose of preventing the jumping.

The crawler monitoring method described with reference to FIG. 9 preferably includes acquiring the information S at a plurality of locations in the crawler circumferential direction. In this case, the behavior of the inner circumferential surface 31f1 of the elastic crawler 31 is monitored in more detail, and thus jumping can be detected in advance with higher accuracy.

Referring to FIG. 8, in the crawler monitoring method with reference to FIG. 9, the information S is information S on the distance D1 between the inner circumferential surface 31f1 at the width direction end 31e of the elastic crawler 31 and the drive wheel 34. In this case, the behavior of the inner circumferential surface 31f1 of the elastic crawler 31 can be easily monitored. Accordingly, in this case, jumping can be detected in advance by a simple method.

According to the present disclosure, it is possible to provide the crawler monitoring system, the crawler apparatus, the crawler vehicle, and the crawler monitoring method capable of preventing the jumping in advance. Further, according to the present disclosure, the countermeasure is taken to prevent the jumping in advance, and thus it is possible to eliminate downtime of the crawler apparatus 3 and the crawler vehicle 1 including the crawler apparatus 3 caused by repairs of the damaged drive projections 34b.

Although the exemplary embodiment of the present disclosure has been described above, various changes can be made without departing from the scope of claims. As described above, the term “crawler monitoring system” in the present disclosure is synonymous with the “crawler monitoring device”. The crawler vehicle 1 is applicable to an agricultural machine (for example, a tractor or a combine). In addition, the crawler vehicle 1 is applicable to a construction machine (for example, an excavator, a dump car, a crane truck, or an aerial work platform).

1. A crawler monitoring system configured to monitor a crawler apparatus including: an elastic crawler provided with a drive projection on an inner circumferential surface; and a drive sprocket including a drive pin capable of pressing the drive projection of the elastic crawler, and being rotatable along the inner circumferential surface of the elastic crawler, the crawler monitoring system comprising:
a sensor configured to acquire information on a distance between the inner circumferential surface of the elastic crawler and the drive sprocket; and
a monitoring member configured to acquire the information from the sensor and monitor whether a measured value measured based on the information is a preset predetermined value or more.

2. The crawler monitoring system according to claim 1, wherein
the monitoring member reduces or stops a rotation of the drive sprocket, or notifies that the measured value is the predetermined value or more when determining that the measured value is the predetermined value or more.

3. The crawler monitoring system according to claim 1, further comprising a heat insulating member that covers the sensor.

4. The crawler monitoring system according to claim 1, further comprising a cushion member that covers the sensor.

5. The crawler monitoring system according to claim 1, wherein
the sensor includes a plurality of sensors disposed in a crawler circumferential direction.

6. The crawler monitoring system according to claim 1, wherein
the sensor is located to be overlapped on a width direction end of the elastic crawler in a crawler width direction as viewed in the crawler circumferential direction.

7. The crawler monitoring system according to claim 6, wherein
the sensor is disposed on a sprocket frame.

8. The crawler monitoring system according to claim 1, wherein
the drive sprocket is disposed at a position higher than a driven sprocket paired with the drive sprocket.

9. A crawler apparatus comprising:
an elastic crawler provided with a drive projection on an inner circumferential surface;
a drive sprocket including a drive pin capable of pressing the drive projection of the elastic crawler, and being rotatable along the inner circumferential surface of the elastic crawler; and
the crawler monitoring device according to claim 1.

10. A crawler vehicle in which a crawler apparatus is disposed on a vehicle front side and a vehicle rear side, the crawler apparatus including: an elastic crawler provided with a drive projection on an inner circumferential surface; and a drive sprocket including a drive pin capable of pressing the drive projection of the elastic crawler, and being rotatable along the inner circumferential surface of the elastic crawler,
the crawler vehicle further including the crawler monitoring system according to claim 1,
the sensor being provided in at least one crawler apparatus of the crawler apparatus on the vehicle front side and the crawler apparatus on the vehicle rear side.

11. The crawler vehicle according to claim 10, wherein
the sensor is provided in at least one crawler apparatus having a large applied load of the crawler apparatus on the vehicle front side and the crawler apparatus on the vehicle rear side.

12. The crawler vehicle according to claim 10, wherein
the sensor is provided in every crawler apparatus.

13. A crawler monitoring method for monitoring a crawler apparatus in which a drive projection provided on an inner circumferential surface of an elastic crawler is pressed by a drive pin provided on a drive sprocket and the drive sprocket rotates along the inner circumferential surface of the elastic crawler, the crawler monitoring method comprising:
acquiring information on a distance between the inner circumferential surface of the elastic crawler and the drive sprocket; and
monitoring whether a measured value measured based on the information is a preset predetermined value or more.

14. The crawler monitoring method according to claim 13, further comprising:
reducing or stopping a rotation of the drive sprocket when it is determined that the measured value is the predetermined value or more or notifying that measured value is the predetermined value or more.

15. The crawler monitoring method according to claim 13, further comprising:
acquiring the information at a plurality of locations in a crawler circumferential direction.

16. The crawler monitoring method according to claim 1, wherein
the information is information on a distance between the inner circumferential surface at a width direction end of the elastic crawler and the drive sprocket.

17. The crawler monitoring system according to claim 2, further comprising a heat insulating member that covers the sensor.

18. The crawler monitoring system according to claim 2, further comprising a cushion member that covers the sensor.

19. The crawler monitoring system according to claim 1, wherein
the sensor includes a plurality of sensors disposed in a crawler circumferential direction.

20. The crawler monitoring system according to claim 1, wherein
the sensor is located to be overlapped on a width direction end of the elastic crawler in a crawler width direction as viewed in the crawler circumferential direction.
